(19) United States
(12) Patent Application Publication
(10) Pub. No.: US 2020/0364720 A1
(43) Pub. Date: Nov. 19, 2020

(54) METHOD AND APPARATUS FOR FACILITATING COMMERCE

(71) Applicant: RADTAB, INC., Pittsburgh, PA (US)

(72) Inventors: Shaun Lally, (US); Nathan Charles Adamson, Charleston, SC (US)

(73) Assignee: RADTAB, INC., Pittsburgh, PA (US)

(21) Appl. No.: 16/874,022

(22) Filed: May 14, 2020

Related U.S. Application Data
(60) Provisional application No. 62/847,432, filed on May 14, 2019.

(51) Int. Cl. G06Q 20/40; G06Q 20/10; G06Q 40/02; G06Q 20/38; G06Q 20/20; G06Q 20/32; G06Q 20/08; G06Q 20/36

(52) U.S. Cl. CPC G06Q 20/4037; G06Q 20/108; G06Q 40/025; G06Q 20/385; G06Q 20/202; G06F 21/602; G06Q 20/4015; G06Q 20/085; G06Q 20/3672; G06Q 20/3674; G06Q 2220/00; G06Q 20/3224

(57) ABSTRACT

A method and apparatus facilitate financial transactions using sources of pre-established funds. A source of pre-established funds can be uploaded to a secure server using an app that is operable on a mobile electronic device. The source of pre-established funds can be used by an owner to initiate a financial transaction, such as by using the app to open a tab at a venue, in which the venue might apply a number of charges for the purchase of food, beverage, merchandise, and the like, and can also permit the owner of the source of pre-established funds to add a gratuity to the tab for final charging to the source of pre-established funds. The source of pre-established funds is usable to complete a financial transaction and to thereby cause a financial obligation that arises from the financial transaction to be paid using the source of pre-established funds.

### CROSS-REFERENCE TO RELATED APPLICATION

The instant patent application claims priority from U.S. Provisional Patent Application Ser. No. 62/847,432 filed May 14, 2019, the disclosures of which are incorporated herein by reference.

### BACKGROUND

### Field

The disclosed and claimed concept relates generally to a method and apparatus for facilitating commerce and, more particularly, to a method and apparatus wherein a number of pre-established sources of funds are usable to perform financial transactions.

### Related Art

Many types of financial transactions are known in the relevant art. Financial transactions typically involve two parties, one of which desires to purchase a good or service from the other for some type of financial consideration such that the financial transaction typically involves some type of an obligation for the one person to pay the other an amount of money. The obligation can be satisfied using any of a variety of payment mechanisms that can include cash, a check, a wire transfer of funds, a credit card or a debit card (which may be collectively or individually referred to hereinafter as credit cards), and the like without limitation. While these various payment mechanisms each have their respective benefits, they also each have their own respective limitations.

It is generally known that credit cards can be lost or stolen and thus compromised. Moreover, in certain situations a credit card can be initially authorized for a financial transaction, but the overall financial transaction might ultimately exceed the amount of available funds that are associated with the credit card, which may result in the credit card ultimately being declined when it is desired to close the financial transaction. Examples occur when an initial credit card swipe is used to open a tab (also known as a ticket or a check) at a bar, a restaurant, or other type of venue, in which situation the credit card typically is authorized for a nominal fixed dollar amount, such as $1 or $10. When additional charges are added to the tab such as through the purchase of food and beverage items, each such purchase results in a corresponding dollar amount being added to the tab. When it is desired to close the tab, the credit card is again authorized by making an authorization call to the credit card company for the full amount of the tab using the Point Of Sale (POS) system at the venue where the tab was created. Since credit cards typically have some type of credit limit, a credit card might be declined in response to the authorization call for the full amount of the tab whereas it had been authorized for the initial $1 or $10 during the initial authorization. In such a situation, the venue must work with the patron to find an alternative payment mechanism, which leads to financial risk for the venue.

Credit card transactions undesirably involve the Underlying Sensitive Information (USI) of a credit card being available for possible misuse. The USI of a typical credit card can include the Primary Account Number (PAN) of the credit card, which may be a string of sixteen digits or other quantity of digits, and can further include the name of the owner of the credit card, the expiration date of the credit card, and a numerical code which can be referred to as a Card Value Code (CVC) or a Card Verification Value (CVV), which may be a three or four digit numerical code, by way of example and without limitation. While such USI is most desirably kept secure at all times, transactions that involve a patron providing a gratuity on the credit card in addition to the conventional charges at the venue are usually not cashed out until after the venue has closed at the end of the day. For instance, when the patron desires to close the tab, an employee at the venue typically runs an authorization operation on the credit card for the full sum of the charges that have accrued to the tab. Such sum typically will be based upon the total of the charges for the purchases of food and beverage, etc., and will additionally include an amount for sales tax, as applicable. The authorization operation involves an Application Programming Interface (API) call to the payment processor that is employed by the venue, with the payment processor then conveying to the credit card company (Visa, Mastercard, Discover, etc.) a request that the issuing bank (Bank of America, Capital One, Barclay's, etc.) who originally issued the credit card to the patron authorize a charge on that credit card for the sum. If the issuing bank determines that a number of conditions exist, such as the credit card having sufficient funds available to it and that the financial transaction appears to be non-fraudulent, the issuing bank will authorize the charge and will return to the credit card company a numeric authorization code. The authorization code is then forwarded from the credit card company to the payment processor and then to the POS, at which point the POS prints a receipt that includes the sum and additionally includes a blank region for the patron to manually add a gratuity. The employee at the venue then typically presents the receipt to the patron for filling it of the gratuity and signature by the patron. However, the gratuity typically is not actually charged to the credit card until a later time when the tab is “cashed out”, which typically occurs at the end of the night after the venue has closed and is performed by a manager or other principal at the venue. Until the time that the tab is actually cashed out, the charge to the credit card is retained as a pending charge, and the USI is stored on a computer that typically is present in the Back of House (BoH) at the venue. The existence of such USI at the venue for a period of time after the patron has left the venue is undesirable because it potentially can be accessed for unauthorized purchases.

Credit card transactions are also typically costly for a venue to accept due to the costs involved. A venue must typically pay a monthly subscription charge to the credit card processor. Moreover, each credit card transaction itself is subject to fees that typically are a percentage of the charged amount plus a fixed fee. By way of example, the total transaction processing fees that are applied to each credit card charge may include an interchange fee that is charged by the credit card company and the issuing bank and can additionally include a markup fee that is charged by the credit card processor. For instance, the total fees might be 2.9% of the total amount that is charged plus a flat $0.30. In certain environments that involve slim margins, such transaction processing fees can become significant.

Furthermore, conventional credit card transactions take a meaningful amount of time. A given credit card transaction might originate at a POS, and the authorization travels from the POS to the payment processor to the credit card company and to the issuing bank for authorization. If the charge is authorized, the authorization code that is returned by the issuing bank is returned in the reverse fashion to the credit card company, to the payment processor, and then to the POS which typically outputs on its visual display a notification such as “APPROVED” or other such notification. While such an authorization process occurs in a matter of seconds, this still takes time and processing power in the form of processing cycles and data transfer bandwidth.

As such, while credit cards and their use in financial transactions have been generally effective for their intended purposes, they have not been without limitation. Improvements would thus be desirable.

### SUMMARY

An improved method and apparatus in accordance with the disclosed and claimed concept advantageously facilitate financial transactions using sources of pre-established funds. In one aspect of the disclosed and claimed concept, a source of pre-established funds can be uploaded to a secure server in accordance with the disclosed and claimed concept using an application, also known as an app, that is deployed and operable on a mobile electronic device that is likewise in accordance with the disclosed and claimed concept. In another aspect of the disclosed and claimed concept, the source of pre-established funds can be used by an owner of the source of pre-established funds to initiate a financial transaction, such as by using the app and selecting the source of pre-established funds to open a tab at a venue or make a payment for a retail purchase, in which the venue might apply a number of charges for the purchase of food, beverage, merchandise, and the like, without limitation, and can also permit the owner of the source of pre-established funds to add a gratuity to the tab for final charging to the source of pre-established funds. In yet another aspect of the disclosed and claimed concept, the source of pre-established funds is usable to complete a financial transaction and to thereby cause a financial obligation that arises from the financial transaction to be paid using the source of pre-established funds.

Tokenization is the process of replacing sensitive, confidential data with unique identification symbols that retain all the essential information about the data without compromising its security. In essence, tokenization seeks to minimize the amount of raw confidential data a business needs to share and keep on hand. Substitution techniques, like tokenization, have been in practice for decades as a way to isolate data in systems.

Encryption, with reversible cryptographic ‘keys’, has been a method of protecting sensitive data. Encryption has been referred to as being the transformation of data into a form unreadable by anyone without a secret decryption key. The purpose is to ensure privacy by keeping the information hidden from anyone for whom it is not intended, even those who can see the encrypted data. For example, one may wish to encrypt files on a hard disk to prevent an intruder from reading them. Encryption has a wide variety of use cases, from cloaking private messages in peer to peer (P2P) apps to transferring sensitive information in a vulnerable environment. But more recently, payment experts are seeing more and more organizations moving from encryption to tokenization as a more cost-effective and secure means to protect and safeguard sensitive information.

In today's environment, one of the most widespread uses of tokenization is in the payments industry. Tokenization allows users to securely store credit/debit/virtual card information in mobile wallets, eCommerce solutions, and POS software allowing the card to be continuously used without exposing the original card information. Payment Card Industry (PCI) standards do not allow card numbers to be stored on a retailer's POS terminal or in its databases (server) after a transaction. To be PCI compliant, merchants must install costly end-to-end encryption systems or outsource their payment processing to a service provider that has a tokenization option.

Tokenization makes unauthorized access to cardholder data much more difficult than the older system in which card numbers were to be stored in undisclosed databases and exchanged freely over networks with or without encryption. Tokenization technology is currently used with sensitive data of all kinds including bank transactions, medical records, criminal records, vehicle driver information, loan applications, stock trading, voter registration, and many more applications.

Apple Pay, Google Pay, Samsung Pay, digital wallets using Stripe & Braintree, banking technologies using Plaid and Dwolla, and eCommerce platforms using Amazon Pay, Square, Shopify, and Paypal are all using tokenization to secure sensitive payment data. Apple Pay's tokenization begins when a user enters the card information into an iPhone or Apple device, either manually or from the device's camera, using Card.io. Apple sends these details to the card's issuing bank or network, which replaces the card information with a series of randomly generated numbers (i.e., a stand-in token). That random number is sent back to Apple Pay and is stored locally on the device itself in what is known as the Secure Element (SE). This token, which looks very different from the card information, is stored on the phone/device and cannot be extracted into anything valuable by unauthorized users. Apple Pay calls their tokens Device Account Numbers.

Android Pay, which consists of Samsung Pay and Google Pay (also known as G Pay), works similarly to Apple Pay. When card information is entered into an Android mobile app, Google creates a stand-in token to represent an actual account number. Apple Pay and Android Pay, function as mobile wallets since the token is stored on the physical device. The benefit to the device owner of having the token stored on the physical device is its ability to be used for Near-Field Communication (NFC) payments, a contactless form of payment that is available even if the user does not have mobile or cellular data connection.

Many mobile apps utilize Stripe, Braintree, and Ayden for their payment services. For example, if someone is purchasing something directly through an app on a phone (e.g. concert tickets, clothes, books, etc.), most of these individual apps use one of these third-party payment processors to capture and store tokens.

Tokenization in E-Commerce functions the same way to protect online shopping activities. For example, when a card is added to Amazon, the card number is tokenized and Amazon keeps the token on file. The sensitive payment information is safe since Amazon uses a unique algorithm in its own tokenization scheme.

There are many different tokenization methods, from cryptographic keys, random method, dynamic/static data masking, vaultless tokenization, de-identification, masking/obfuscation algorithms, static table method, static driven method, hash tables, and random table generator algorithms. Most tokenization methods fall into one of three categories: reversible algorithms, one-way non-reversible cryptographic functions, or static tables mapped to randomly generated token values.

The first step in tokenization of card information is capturing the key information, starting with the primary account number (PAN).

The 1st digit of a PAN relates to the card brand.

Visa cards—Begin with a 4 and have 13 or 16 digits

MasterCard cards—Begin with a 5 and has 16 digits

American Express cards—Begin with a 3, followed by a 4 or a 7 and has 15 digits

Discover cards—Begin with a 6 and have 16 digits

Digits 2 through 6 of the PAN provide an identifier for a particular institution that has issued the card. This is also called a BIN (Bank Identifier Number, or IIN—Issuer Identification Number—for American Express). Digits 7 through 15 of the PAN provide the Unique Personal Identifiers which is the actual account number of the card and is unique to the issuer (e.g. debit vs credit card, corporate rewards cards). Digit 16 of the PAN is known as the check digit. This last digit verifies card numbers for accuracy to make sure that the digits were not input incorrectly.

The tokenization process also captures:

CVC or CVV: 3 or 4 digit code

Expiration Date: MM/YYYY

From this information, a payment gateway, which is a merchant service provided by an e-commerce application service provider that authorizes credit cards, can identify the card brand, issuing bank, and account number of the cardholder, CVC/CVV code, and expiration date, all of which is tokenized.

A vendor such as a mobile app may use a third party processor for their token and payment service. Most third party processors have a Software Development Kit (SDK) that is built into a mobile app which functions as a mobile wallet interface to prompt the user to enter the card information (a Visa card in this example). When card details are added, the third party processor's API captures the card brand, issuing bank, and account number and sends that information to Visa which sends it to the issuing bank to be verified. If successful, the third party processor tokenizes the card details. This newly created token is stored by the third party processor for use on the mobile app.

However, the third party processor's token in this example is a single use token that can only be used on this mobile app and only for this singular transaction. The third party processor may have tokenized multiple instances of the same card at the same time depending how many times a user has uploaded the same card to different apps and platforms that use the third party processor's payment gateway. The third party processor's API can only charge this card on their network. The third party processor may charge the mobile app a fee of 2.9% plus a $0.30 transaction fee for all platforms no matter the use case.

The Token Service of the inventive system requires the same card data that other tokenization services require, such as the PAN number, Expiration date, and CVC. These details are captured by the inventive API in a digital wallet interface of a mobile app or eCommerce platform where they are either entered manually or scanned by the device's camera.

These captured details are known as USI. When any USI is captured by the inventive API, it is automatically encrypted by a ciphertext by the inventive Transport Layer Security (TLS) server protocol. The TLS server protocol consists of cryptographic protocols designed to provide communications security over a computer network and provides an inventive API with a Point to Point Encryption (P2PE) solution. The encrypted USI is sent to the corresponding card brand which passes it along to the issuing bank where an Authorization Call is made. This Authorization Call is performed every time a card is added or a transaction takes place. An Authorization Call results in a hold on the card, in the amount of $1 or $10 or sometimes $0 depending on the card and issuing bank, to verify the card is chargeable and in good standing. If the Authorization Call is successful, the encrypted USI is tokenized by the inventive Token Service utilizing a Random Number Table Generator Algorithm (RNTGA) API command. It is important to note that each card's USI information is never exposed on any servers and that the inventive is fully PCI Compliant. This is the beginning of the inventive Smart Token.

The inventive Smart Token is stored in a secure environment in the cloud called the Universal Token Vault (UTV). The UTV stores the Smart Token along with a unique identification id called a Token Profile. The Token Profile is created within the Token Service at the same time the Smart Token is created. The Token Profile id identifies the Smart Token owner and is responsible for passing a Transaction Token, a unique token for each individual payment transaction, to the appropriate API endpoints for payment processing. Furthermore, the inventive Token Profile and Smart Token allows the inventive API to capture data associated with each Transaction Token for the same Smart Token across multiple API endpoints and gateways while keeping the data safe, secure, and universal. The inventive API is fully compliant with General Data Protection Regulation (GDPR) and Payment Service Directive Revised (PSD2) Regulation.

All newly created Smart Tokens are given a Token Profile id. Engineered after a “token lookup table”, this advantageously acts as a “placeholder” for each user's first Smart Token. For example, a user adds a Bank of America Visa card to a mobile app using the inventive API and is assigned a Token Profile id: 123456abc within the UTV. When the user with the same mobile app login verification adds another card to the UTV, such as a Capital One Mastercard, the new card will also be assigned to Token Profile id: 123456abc. The Token Profile of an app user can advantageously be accessed in other apps that are integrated with the inventive API. This is accomplished by way of security verifications done by the app user, such as biometrics or text/email verification that is performed when the user adds the first card to the inventive UTV.

The Token Profile id is sent with the Transaction Token and logs of all the transactional data during the transaction which is then captured by the Smart Token within the inventive UTV. This Token Profile id for a user is first created when the user's first Smart Token is created. The transactional data sets are captured and saved to the Token Profile via webhooks connected to the inventive API that is connected into a developer's mobile app or eCommerce website. These webhooks update the Token Profile whenever the user's Smart Token is used or certain events take place, such as creating a Transaction Token. Developers using the inventive API can create their own unique webhooks that can update the user's Token Profile. However, app developers can only access data saved from their own platform.

For example, a developer with a sporting venue app using the inventive API can create its own webhooks to securely collect transactional data (e.g., purchased merchandise, food, or drink), tickets, and assigned seats to be saved in the Token Profile of the season ticket holders using their app. This information would be captured by the Token Profile id that is sent to an API endpoint with the Transaction Token of the Smart Token, which is used and stored in the inventive Token Profile. Another example would be a restaurant reservation app using the inventive API can add webhooks to keep track of purchases (e.g. meals, favorite drinks, preferred seating, gift cards) made as a result of a reservation.

A Transaction Token of the inventive system is a single use token of the Smart Token created for a user's financial transaction on a platform using the inventive API. This Transaction Token is created when the inventive Token Service runs an Authorization Call on the Smart Token at the time of the transaction; this occurs for every pending transaction. This Transaction Token along with the Token Profile id is sent to the API endpoint from the inventive API for the payment to be processed. After the payment has been processed all transactional data is tagged with the Token Profile ID. The Transactional Token is only good for that single authorized transaction. If a second transaction occurs, another Authorization Call on the Smart Token is made which would create a different Transaction Token.

The inventive API captures the card's USI and determines the card brand from the first digit and the issuing bank from the BIN. The encrypted card USI is routed to the API endpoint of the issuing bank by the card brand that runs an Authorization Call on the card.

If the Authorization Call is successful, this means the card is chargeable and in good standing. A response (Authorization Call id) is sent from the card brand and the issuing bank back to the inventive Token Service, which is the unique id for the successful authorization of the user's card. The inventive Token Service tokenizes the Authorization Call id along with the card's encrypted USI to create a Smart Token. This is the token that is stored within a user's Token Profile and will generate the one time use Transaction Token when an Authorization Call request is made again at a later date to authorize a user's transaction. After the transaction is completed, the Transaction Token is no longer valid and just the original Smart Token remains.

When a successful Authorization Call id is received, the inventive Token Service runs an RNTGA API command. The term “table” in RNTGA refers to a concept of how that tracks the algorithms used in the tokenization process which sorts the created Smart Tokens by Token Profile id, card brand, issuing banks, token users (app users and app profiles), and server timestamps of when the Smart Token is created. The RNTGA API command is made against a card's encrypted USI, Authorization Call id, and a random number, such as a parameter known as an “argument”. The API command is accomplished through a library code hosted in the inventive Token Service's backend server code. This secret module has algorithm functions that generate random tokens using the RNTGA API command.

For example, the inventive Token Service's RNTGA API command request will request a random value response or simply a token of an AMEX card's USI. The basic API command function that generates binary sequences of random bytes (numbers and letters) may looks as follows:

>>>secrets.radtoken_bytes( )
“number”: “375555555554444”,
“verification_value”: “4224”,
“month”: “01”,
“year”: “2024”

Invoking the “radtoken_bytes( )” function without any arguments returns a token with a default length of the encrypted card USI given. However, the inventive Token Service gives this API command an argument, such as a random number like 20, which takes the American Express USI to create a Smart Token. When the Smart Token is created, an “id” called a Token Profile is created unless the user adding the card already has a Token Profile from the creation of a previous Smart Token.

>>>secrets.radtoken_hex(20)
‘86f41a39c3a243fd22d96228eaeb23a60df36e76’
“id”: “token_1Gcaey2eZvKYlo2C1GZwnbKi”,

To create a Transaction Token, the inventive Token Service combines the Smart Token with the successful Authorization Call id response from the card brand and issuing bank using an API call. The created Transaction Token is only code for this unique transaction.

>>>secrets.radtoken_hex(20)(authid)
‘1476f4cfa96f20af2ca8cfdf9c5920f54d78f1b835318d729ceec2a72403cc29’
“id”: “token_1Gcaey2eZvKYlo2C1GZwnbKi”,

As demonstrated in this example, each number or letter in the sequence is rendered as two hexadecimal digits and, when the inventive Token Service requests a Transaction Token with an argument of 20, the resulting string will be 40 characters long. When the inventive Token Service requests a Transaction Token of a Smart Token with an argument of 120, the resulting string will be 240 characters long.

The random argument (20 in the instant example) used to create this Transaction Token is saved with the Token Profile so that the Transactional Token can be detokenized with the original command line back to the card's original encrypted USI for transactions and payment gateways that don't use network tokenization.

Each payment gateway has its own API endpoint URL which allows the inventive API endpoint URL to communicate using HTTP Basic Authentication, which is a method for an HTTP user agent (e.g. a web browser) to provide a secret user and password when making a request, in return to get a response. For example, certain POS machines use a third-party API, such as Omnivore, which allows the inventive system to send a Transaction Token to the merchant's revenue center id within the merchant's POS system and the POS forwards this information to the correct API endpoint.

The following are a list of API endpoint urls for popular payment gateways and third party processors:

First Data: https://secure.linkpt.net:1129/

World pay: https://trans.worldpay.us/cgi-bin/process.cgi

Wire card: https://c3.wirecard.com/secure/ssl-gateway

Ayden: https://pal-live.adyen.com/pal/servlet/

Stripe: https://api.stripe.com/v1/

Braintree: https://api.raintreegatew

The inventive API adds support for developers to use their existing Apple Pay integration with any gateway or endpoint that supports network tokenization. This allows the developer's Apple Pay Provisioning Certificate (which is a payment processing certificate that is associated with a merchant ID that is used to encrypt payment information) to not be limited to using only a single gateway or merchant id within their app, such as only using one third party processor. Using the inventive API, the overall transaction flow is similar to a traditional Apple Pay payment flow with the difference being that the inventive API becomes the Apple Pay Provisioning Certificate issuer and is responsible for decrypting the payment token on behalf of the chosen gateway of the developer. This process is the same for Google Pay.

The inventive API can also send Transaction Tokens to third party mobile app API endpoints on a hardware device such as a POS using third party POS APIs. The inventive API communicates to the POS machine API that can create and open tickets as “ticket ids”. For some POS machines, access to the POS is obtained through a middleware company. The inventive system has its own custom built APIs for Oracle MICROS/Simphony, Toast POS, and NCR Aloha, the three largest POS systems in the hospitality industry. For example, ticket id: 414 is a bar tab owned by the API app user “414 Mike Smith”. The inventive system sends Mike Smith's Transaction Token to the third party mobile app which then passes it to a POS API which then passes it to the local merchant processor to process that ticket for the amount of food and beverage purchases and a tip on Mike Smith's tab. The inventive system requires the third party mobile app to have a Developer API Key, which is a unique identifier used to authenticate to an API a user, developer, or calling program. The Developer API Key is issued by the inventive system to connect to the inventive Token Service and UTV.

Benefits of the inventive Token Service, Token Profile, Smart Token, Transaction Token, and UTV are set forth below. Other advantages will be apparent.

The inventive system provides an ability to add a new mobile app user's primary and secondary payment card from the UTV to the digital wallet of a third party mobile app or web site that uses the inventive API (biometric face recognition/fingerprint/device id/password saved from the first time the card is added). This verification service works with Strong Customer Authentication Regulation (SCA).

The inventive system automatically saves a digital copy of the itemized transactional receipt for all purchases made with a Transaction Token of a Smart Token into the cloud; this applies for “Card Present” and “Card Not Present” transactions. This information is displayed by the issuing bank in their respective mobile banking app if they were connected to the inventive API. This also allows the customer to see a full itemized receipt.

The inventive system is compliant with 3-D Secure Three-Domain Secure (3DS). When a user adds a card for the first time, the issuing bank prompts for a security check to verify the cardholder, such as bank login.

The inventive Token Profile is an effective solution to tracking and updating loyalty data for each app that has access to a user's Token Profile via webhooks; to retain coupons/gift cards and apply them automatically to transactions when a Transaction Token of a Smart Token is used.

The inventive system has the ability to automatically switch the default payment card in an app's digital wallet for a given transaction for certain merchant category code that can benefit the cardholder's reward and loyalty points. This is done by identifying card type (corporate, rewards, etc.) and matching with Merchant Category Codes (MCCs), which is used to classify a business by the types of goods or services it provides, of pending transactions done by webhooks connected to the user's Token Profile. For example, the Discover Savour Card is automatically made the primary card in a digital wallet for purchases related to MCCs for dining and restaurants. The Uber Visa Card can be made the primary card for Uber, and Ubereats and travel purchases.

The inventive system has the ability for merchants to use more than one merchant processor to automatically switch to the system that has the lowest transaction fees for that particular transaction.

The inventive system has the ability to save geolocation data when a Transaction Token of a Smart Token is added, updated, authorized, or transacted against to prevent fraud, but also to show promotions and rewards for a card company's customers.

The inventive Transaction Token, Smart Token, and UTV is usable in open banking and for P2P payments with the Token Service's ability to tokenize bank accounts.

The inventive system integrates token schemes from third party digital wallets and token services to the UTV and also has the ability to export Smart Tokens to these services as well.

The inventive Token Profile has the ability to integrate third-party data, such as a user's passport or driver's license. All data would be tokenized by the inventive Token Service.

The inventive system has the ability to create “Situational Tokenization” for different tokenization methods depending on the data needing to be tokenized. For example, a token for a hospital bill shouldn't be saved in the UTV if this is a one time transaction.

The inventive system relates to two different products. The first being the inventive native Android and iOS mobile app that allows the opening, viewing, and full payment of hospitality industry tabs through multiple POS machines and payment gateways. The second is the inventive API, Token Service, Smart Token, Token Profile, and Transaction Token.

The inventive mobile app provides several transaction triggers from geolocation webhooks. For example if a user's device leaves a 100-foot or other predefined perimeter of the bar's physical address, the bar tab will close and be paid on the merchant's POS machine and processor. Another example is the automate tab mechanism that authorizes the opening of a tab when a user walks into a venue and closes the tab when the user leaves the venue. A transaction trigger is also from a server timestamp webhook indicating the bar closing at 2:00 AM, for example, and triggers an open tab to be closed.

The inventive system's Token Service allows Transaction Tokens to be sent to any whitelisted API endpoint of a payment gateway or processor that the POS machine has installed locally on the BoH of the venue or within the cloud.

The inventive system has the ability to match live transactional data with third party scanned identification of a customer (passport, driver's license, or ID).

The inventive system's Token Service has the ability to create custom Authorization Calls on pending transactions. For example, as a bar tab amount increases from having items added to a POS ticket, the inventive system can run another authorization each time an item is added, or it can be triggered to do so as specific dollar amounts such as $100, $200, $300, etc.

The inventive system's API can connect multiple revenue systems for a POS environment in the cloud. For example, a tab using the inventive system can be opened and closed from any of a plurality of revenue centers (inside bar, outside, and upstairs) at a venue. Splitting of tabs is accomplished by the use of text message, phone number, contact, social list, or NFC of a nearby mobile device.

The inventive system has the ability to add custom data fields to a POS ticket such as, sporting venue seat #, mobile number, VIP status.

The inventive API Token Service creates a Token Profile when a user's first Smart Token is created. This Token Profile will be used in any third party apps using the inventive API.

The inventive API uses Token Profile webhooks to add an ID to data sets for transactional data. The inventive API can provide an ability to develop custom webhooks to add data to a Token Profile.

The inventive Token Service tokenization method combines a successful Authorization Call ID of the user's card's encrypted USI.

The inventive API uses a one time Transaction Token of a Smart Token for a single use transaction.

The inventive API uses a UTV allowing Smart Tokens to be universal for all mobile apps and platforms integrated with the inventive API.

The inventive API allows third party biometric & behavioral mobile app data to be tokenized and stored within the Token Profile for Smart Tokens. The inventive API can pass the tokenized biometric mobile app data along with a Transaction Token to various API endpoints.

The inventive API has the ability to log and identify biometric success/failure attempts within a Token Profile for individual Smart Tokens. This can be sent along with Transaction Tokens to third party systems to verify the transaction. For example, a transaction that had 5 unsuccessful facial biometric attempts may be a high risk transaction.

The inventive API has the ability to create additional UTVs for sensitive data such as health records, SSN, and other data and enables integration of third party token schemes from other services and vaults.

The inventive API has the ability to merge the existing UTV, Token Profiles, and Smart Tokens onto a Blockchain which is an open, distributed ledger that can record transactions between two parties efficiently and in a verifiable and permanent way.

The following is an example of a Smart Token to Transaction Token for a credit card charge by the third party processor in a mobile app using an aspect of the inventive API:

1. A mobile app user wants to buy something for $10 on an app that uses a third party processor for its payment processing.
2. This mobile app uses the inventive API, and the user already has a primary card in his/her mobile app's wallet (i.e. a Smart Token associated with a Token Profile stored in the UTV).
3. The user hits “pay” on the app. This creates a payment API request that is done by the mobile app. This request is sent to the inventive API. The request would be different for each mobile app but will have the amount ($10 in this example), primary card of the user (i.e. Smart Token), and the API endpoint for the involved processor.
4. This API request from the mobile app causes the primary card or Smart Token to be sent from the UTV to the Token Service to create a Transaction Token for $10.
5. The Token Service de-tokenizes the Smart Token to the original encrypted USI and runs an “Authorization Call” for $10. Such an authorization call is sent from the Token Service to the credit card brand and then to the issuing bank using HTTP Basic Authentication, i.e., standard encryption. A successful Authorization Call ID in the form of an authorization code is created by the issuing bank and is sent back to the card brand and to Token Service.
6. The Token Service uses the successful Authorization Call ID, random argument (random number), and original encrypted USI to create a single use Transaction Token.
7. Transaction Token is sent from the Token Service to the API endpoint of the mobile app's payment processor by HTTP Basic Authentication.
8. The third party processor accepts the incoming Transaction Token under HTTP rules since it is coming from another API endpoint that is a part of a mobile app that is integrated with the third party processor. This only happens when all API keys for the parties involved match (mobile app API, inventive API, third party processor API).
9. When the Transaction Token arrives at the API endpoint for the third party processor it will automatically detokenize into the original unencrypted USI, Authorization ID, and random argument. There is a secure direct line of communication from the Token Service API, improved mobile app API, improved third party processor API that allows this command for this Transaction Token, and this secure direct line of communication communicates the random argument to the API endpoint of the third party processor, which enables the third party processor to detokenize the transaction token.
10. The third party processor runs this as a one-time transaction by sending the authorization ID to the card company and a $10 charge will occur on the user's card. The third party processor does this by sending the authorization ID to the card brand of USI which then sends the authorization ID to the issuing bank and issuing bank sends funds to the acquiring bank, i.e., the acquiring bank account set up by the third party processor.
11. The user receives a successful payment response on the mobile app knowing the transaction is complete. Transaction data, for example the amount of the transaction, items bought, geolocation of where the transaction occurred, and other data, are then added to the Token Profile.
12. At the end of the business day, the third party processor is electronically paid its transaction fees, for example 2.9%+$0.30, and the remaining amount from the $10 purchase is deposited in the merchant account. The 2.9%+0.30 transaction fee includes the markup fee (third party processor's fee), interchange fees (card brand and issuing bank's), and assessment fee (fee paid by the third party processor to the card brands to accept their card).

Accordingly, an aspect of the disclosed and claimed concept is to provide an improved method and apparatus that enable a number of pre-established sources of funds to be employed in initiating financial transactions. As employed herein, the expression “a number of” and variations thereof shall refer broadly to any non-zero quantity, including a quantity of one.

Another aspect of the disclosed and claimed concept is to provide an improved method and apparatus that enable a number of pre-established sources of funds to be added to a secure vault by transforming their USI into a smart token and storing the smart token in a secure vault.

Another aspect of the disclosed and claimed concept is to provide an improved method and apparatus that enable a number of pre-established sources of funds that are stored in a secure vault to be used to complete a number of financial transactions and to be usable to pay an obligation to another that arises from each such financial transaction.

Another aspect of the disclosed and claimed concept is to provide an improved method and apparatus that facilitate the performance of the number of financial transactions in a fashion that reduce any or all of expense, processing bandwidth, and security risk.

These and other aspects of the disclosed and claimed concept are provided by an improved method and by an improved apparatus that implements the improved method, specifically an improved method of using a source of pre-established funds to perform a financial transaction with another, the another employing a payment processor, the financial transaction including a number of charges, at least a subset of the charges of the number of charges being added by the another during the financial transaction, the financial transaction including an obligation to pay the another for the number of charges, the source of pre-established funds having an amount of available funds. The method can be generally stated as including receiving an initiation input that requests an initiation of the financial transaction, detokenizing a token that is stored in a storage and that is representative of the source of pre-established funds to form a set of data that comprises a Primary Account Number (PAN) of the source of pre-established funds, communicating to at least one of a credit card company and an issuing bank the PAN and an authorization request that the issuing bank authorize use of at least a portion of the amount of available funds to pay the obligation, receiving an authorization code that is representative of an agreement by the issuing bank to make available the at least portion of the amount of available funds, and responsive to the receiving of the authorization code, sending to the another an initiation notification that the financial transaction has been initiated.

Other aspects of the disclosed and claimed concept are provided by an improved method and by an improved apparatus that implements the improved method, specifically an improved method of enabling a financial transaction using a source of pre-established funds having an amount of available funds to pay an obligation that is owed to another who employs a payment processor. The method can be generally stated as including, responsive to a predetermined event, communicating to at least one of a credit card company and an issuing bank an authorization request that the issuing bank authorize use of at least a portion of the amount of available funds to pay the obligation, receiving an authorization code that is representative of an agreement by the issuing bank to make available the at least portion of the amount of available funds, generating a transaction token that is based at least in part upon the authorization code and that can be detokenized to form a set of data that includes the authorization code, and sending the transaction token to the payment processor in payment of the obligation.

Other aspects of the disclosed and claimed concept are provided by an improved method and by an improved apparatus that implements the improved method, specifically an improved method of making available a source of pre-established funds to perform a number of financial transactions, the source of pre-established funds having an amount of available funds. The method can be generally stated as including receiving a registration input that comprises a Primary Account Number (PAN) of the source of pre-established funds, communicating to at least one of a credit card company and an issuing bank the PAN and a request that the issuing bank authorize use of at least a portion of the amount of available funds, receiving an authorization code that is representative of an agreement by the issuing bank to make available the at least portion of the amount of available funds, responsive to the receiving of the authorization code, generating a token that is representative of the source of pre-established funds and that can be detokenized to form a set of data that includes the PAN, storing the token in a secure storage, and outputting an indication that the source of pre-established funds is available for use.

### BRIEF DESCRIPTION OF THE DRAWINGS

A further understanding of the disclosed and claimed concept can be gained from the following Description when read in conjunction with the accompanying drawings in which:

FIG. 1 is a schematic depiction of a system that includes a mobile electronic device that is in communication with an enterprise data system in accordance with the disclosed and claimed concept;

FIG. 2 is a flowchart depicting certain aspects of an improved method in accordance with a first embodiment of the disclosed and claimed concept;

FIG. 3 is a flowchart depicting certain aspects of an improved method in accordance with a second embodiment of the disclosed and claimed concept; and

FIG. 4 is a flowchart depicting certain aspects of an improved method in accordance with a third embodiment of the disclosed and claimed concept.

Similar numerals to similar parts throughout the specification.

### DESCRIPTION

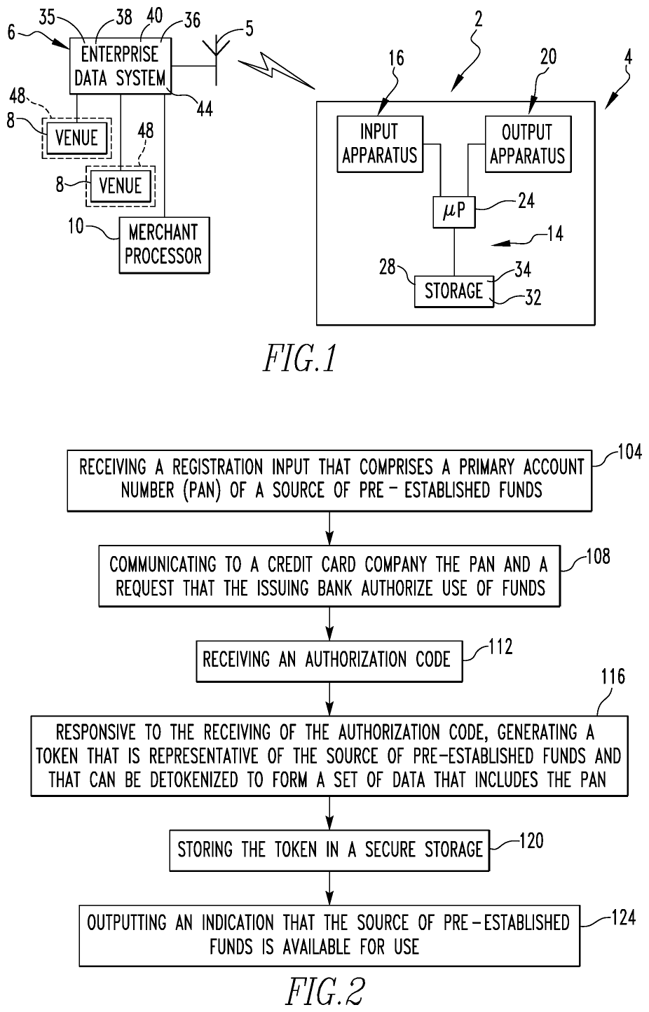

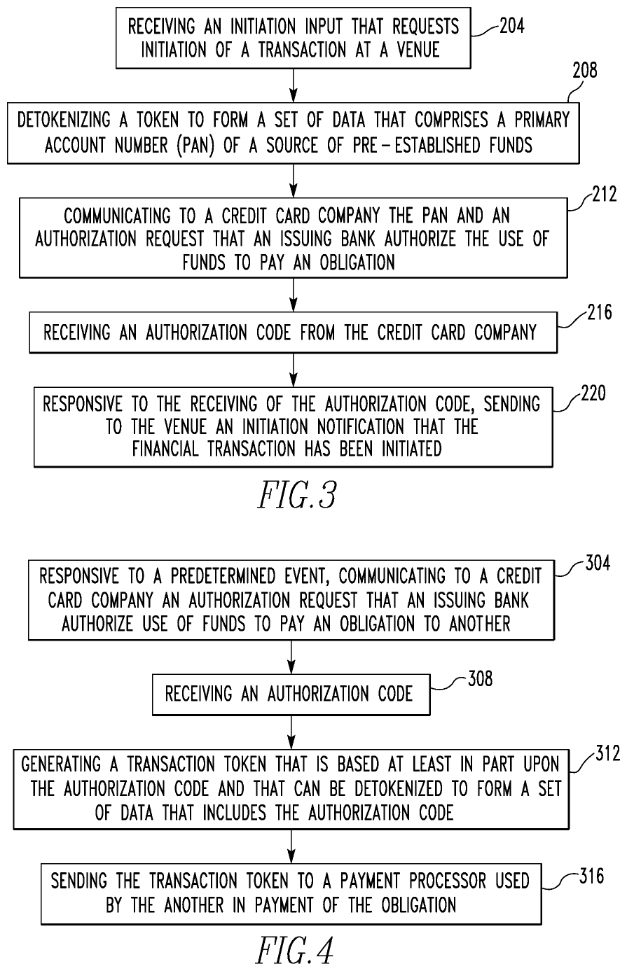

An improved system 2 in accordance with the disclosed and claimed concept is depicted generally in FIG. 1 as including a mobile electronic device 4 that is in accordance with the disclosed and claimed concept that is in communication with a wireless data network 5 that is connected with an enterprise data system 6 that is likewise in accordance with the disclosed and claimed concept. The enterprise data system 6 is an improved apparatus that can perform a number of improved methods that are also in accordance with the disclosed and claimed concept. The mobile electronic device 4 and the system 2 likewise each constitute an apparatus that is in accordance with the disclosed and claimed concept and that likewise can perform improved methods that are also in accordance with the disclosed and claimed concept.

The enterprise data system 6 is depicted in FIG. 1 as being in communication with a pair of venues that are each indicated at the numeral 8 and as also being in communication with a merchant processor that is indicated at the numeral 10. The two venues 8 are representative of any number of venues with which the enterprise data system 6 can be connected and with which a user who uses the mobile electronic device 4 can perform financial transactions using one or more sources of pre-established funds. The venues 8 can be any type of business or other operation that is capable of performing financial transactions that involve an obligation to pay an amount of money to the venue 8 and thus can include bars, restaurants, theaters, stadiums, and the like without limitation.

As will be set forth in greater detail elsewhere herein, the exemplary venues 8 are places where the user can open a tab, also known as a check or a bill, in which the venue 8 applies charges as part of the financial transaction, with the charges being based upon purchase of food, beverages, services, merchandise, and the like without limitation, and which are typically applied over a period of time while the tab is open, i.e., active and chargeable. The merchant processor 10 is similar to a venue 8, except that the financial transaction that is conducted with the merchant processor 10 typically is more in the nature of a single purchase. That is, whereas a tab might be opened at a venue 8 and over the course of a number of hours the user might gradually accrue charges that are applied to the tab for the gradual purchase of beverages, food items, pieces of merchandise, etc., with the tab being opened and capable of being charged over a period of time, such as while the user is physically situated at the venue 8, the transaction with the merchant processor is typically orchestrated by a merchant app that is executed on the mobile electronic device 4. That is, and as will be set forth in greater detail elsewhere herein, a mobile vendor app may be executable on a mobile electronic device 4 than enables the user to place items or other things for purchase into a virtual shopping cart and can then execute a purchase command wherein the mobile vendor app initiates operations that result in a payment to the merchant processor 10 via operation of the enterprise data system 6. The merchant processor 10 is representative of any of a wide variety of different merchant processors that are used by merchants and merchant apps to conduct financial transactions with credit card companies and issuing banks on behalf of the merchants, with each such merchant selecting a corresponding merchant processor, it being understood that a plurality of merchants likely will be using the same merchant processor to conduct their respective credit card transactions.

The mobile electronic device 10 can be said to include a processor apparatus 14, an input apparatus 16, and an output apparatus 20. The input apparatus 16 provides input signals to the processor apparatus 14, and the output apparatus 20 receives output signals from the processor apparatus 14. The input apparatus 16 can include any of a wide variety of input devices such as keys the keypad, a camera, a touch sensitive overlay on a touchscreen, and the like without limitation, and also includes a receiver portion of a wireless transceiver that is in communication with the wireless data network 5 and a GPS receiver. The output apparatus 20 likewise can include any of variety of output devices such as a visual display portion of a touchscreen, a loudspeaker, lights, and the like without limitation, and also includes a wireless transmitter portion of a wireless transceiver that is in wireless communication with the wireless data network 5.

The processor apparatus 14 can be said to include a processor 24 that can be in the nature of a microprocessor or other processor and that is in communication with a storage 28. The storage 28 can be any of a wide variety of storage devices such as RAM, ROM, EEPROM, FLASH, and the like without limitation and functions as an internal storage area of a computer. The storage 28 has stored therein a number of routines that are indicated generally at the numeral 32 and also has stored therein various data that are indicated generally at the numeral 34. The routines 32 are executable on the processor 24 to cause the mobile electronic device for to perform various operations. As such, the storage 28 can likewise be said to constitute a non-transitory computer readable storage medium having stored thereon software instructions that, when executed by the processor 24, cause the processor 24 to generate control signals for controlling various operations of the mobile electronic device 4. The routines 32 can include various mobile applications, also known as mobile apps, that can be downloaded via the wireless transceiver on the mobile electronic device for the interface with the wireless data network 5. Such mobile apps can include an improved app such as which enables a tab to be opened on behalf of the user at one of the venues 8. The mobile apps can further include any number of merchant apps, also known as vendor apps, that enable commerce with a particular merchant and which enable a financial transaction to be completed with a corresponding merchant processor that is used by the merchant, such as the exemplary merchant processor 10.

The enterprise data system 6 can be cloud-based or can be in the form of a set of dedicated servers with processors and the like, depending upon the needs of the particular application. The enterprise data system 6 can be said to include and I/O subsystem 35 that interfaces with the wireless data network 5, the venues 8, and the merchant processor 10. The I/O subsystem 35 also communicates with credit card companies such as Visa, Mastercard, Discover, American Express, and the like and potentially could communicate directly with issuing banks, i.e., banks such as Bank of America, Capital One, Barclay's, and the like, by way of example, who issue the credit cards that become the basis for pre-established sources of funds.

The enterprise data system 6 further includes a storage 36 and a processor 38 that are in communication with one another and in communication with the I/O subsystem 35. The storage 36 has a number of routines 40 stored therein and various data stored therein that are indicated at the numeral 44. The storage 36 includes a UTV that is a secure storage and which has stored therein a number of smart tokens that are each representative of the Underlying Sensitive Information (USI) of a corresponding one of the number of pre-established sources of funds, some of which are owned by the user of the mobile electronic device 4, and others of which are owned by other users of other mobile electronic devices, by way of example. Pre-established sources of funds can include credit cards (which, in the examples given herein are deemed to include debit cards) and can include other sources of funds such as gift cards, merchant credits, and the like without limitation.

The routines 40 can be in said to include a token service that is in the form of an API that performs various operations with tokens. For instance, the user of the mobile electronic device 4 can employ the improved app that is executable thereon to upload the USI of a credit card, for example, for storage in the form of a smart token in the UTV. The user can key in the USI information using a keypad of the input apparatus 16 or potentially can take a photo of the credit card using a camera of the input apparatus 16 in order to provide the Primary Account Number (PAN), the expiration date, the name of the card, and the CVC or CVV, which together form the USI, to the token service API. The token service API tokenizes the USI into a smart token, and the smart token is stored in the UTV. In this regard, it is understood that the smart token bears little resemblance to the USI, and thus the USI is secure since it is saved in the UTV only in tokenized form.

The process of adding a source of pre-established funds, such as a credit card, into the UTV is depicted generally in FIG. 2. The operation can begin, such as at 104, where a registration input is received at the enterprise data system 6, with the registration input including the USI of the credit card, by way of example, that the user wishes to add to his or her token profile in order to be able to use the credit card as a source of pre-established funds for use in performing future financial transactions. The USI typically will include the PAN, the expiration date, the CVC or CVV, and the name on the credit card. In doing so, the USI is communicated from the improved app on the mobile electronic device 4 to the enterprise data system 6 using HTTP basic authentication, and thus the data is encrypted when being communicated through the wireless data network 5 to the enterprise data system 6.

Processing continues, as at 108, where the enterprise data system 6 communicates to the credit card company of the user's credit card a request that the issuing bank that issued the credit card authorize the use of funds. In the depicted exemplary embodiment, the request is communicated from the data system 6 to the credit card company, and the credit card company forwards the request to the issuing bank. A credit card or other source of pre-established funds will have an amount of funds that are available, and this first request is to establish that with the issuing bank that the card is valid and chargeable at that time. If the issuing bank determines that the credit card is valid and chargeable, the issuing bank will generate an authorization code which typically is a numeric code, and which is communicated back to the credit card company and thereafter to the enterprise data system 6.

Processing continues, as at 112, where the authorization code is received at the enterprise data system 6. Processing then continues, as at 116, in which, responsive to the receiving of the authorization code at the enterprise data system 6, the token service API generates a smart token that is representative of the source of pre-established funds and that is based upon the USI of the credit card, most typically the PAN. In particular, the smart token that is generated by the token service API is capable of being detokenized by the token service API into a set of data that includes the PAN. The smart token is then stored in the UTV, as at 120. In this regard, the token service will generate a token profile of the owner, and the smart token that represents the pre-establish source of funds will be stored as part of the token profile.

The enterprise data system 6 then outputs an indication, as at 124, that the credit card that has been uploaded is now stored as a pre-established source of funds and is available for use by the user in the conducting of financial transactions. This indication is then communicated over the wireless data network 5 to the mobile electronic device 4 and is received by the improved app that is running on the electronic device 4, and this results in the improved app outputting some type of a notification, such as a visual notification that is output on the visual display of the mobile electronic device 4, or other such notification, advising that the credit card is now usable on the app.

With the credit card now stored in the UTV in the form of a smart token and thus usable as a source of pre-established funds that are usable in order to conduct financial transactions, the user is now able to use that source of pre-established funds to, for instance, start a tab at a venue such as one of the venues 8. For instance, the user may start the improved app on the mobile electronic device 4 and may receive a visual listing of various venues that are available for selection and for the creation of the tab using the improved app. For instance, the various available venues might be output in terms of preference, frequency of use, geographic proximity, etc. When the user selects a particular venue 8 for which to generate a tab, the improved app communicates through the wireless data network 5 an initiation input that is received, as at 204, at the enterprise data system 6 and is seen as a request for an initiation of a financial transaction at that particular venue 8. The token service then detokenizes, as at 8, the smart token into a set of data that comprises a PAN of the source of pre-established funds.

In this regard, it is assumed that the user is employing the aforementioned source of pre-established funds in order to start the tab at the venue 8, it being understood that the user can upload a plurality of credit cards and the like according to the flowchart of FIG. 2 in order to have a plurality of sources of pre-established funds that are selectable for use in generating tabs at venues 8 and for use in conducting other financial transactions. In such a situation, the user might input a selection input to select a preferred source of pre-established funds from among a plurality of sources of pre-established funds for the creation of a particular tab in a particular venue 8. All such sources of pre-established funds will be stored in the UTV as smart tokens under one token profile that corresponds with the owner.

Processing continues, as at 212, wherein the enterprise data system 6 communicates to the credit card company of the source of pre-established funds the PAN and potentially other USI, along with an authorization request. The authorization request is actually a request that is directed to the issuing bank and is communicated from the credit card company to the issuing bank to see if the source of pre-established funds remains valid and chargeable for the purpose of paying an obligation that arises from a financial transaction. If the issuing bank determines that the credit card remains valid and chargeable, it will generate an authorization code that is sent back to the credit card company, and the credit card company sends the authorization code back to the enterprise data system 6. The authorization code is therefore received, as at 216, at the enterprise data system 6 and, responsive to such receiving of the authorization code, the token service API generates a transaction token and sends, as at 220, an initiation notification to the venue 8 indicating that the financial transaction, i.e., the tab, has been initiated. This notification typically is sent to the POS system at the venue 8 and includes the first and last name of the user to enable the venue 8 to match the newly created tab with the user.

The aforementioned transaction token that was generated by the token service API is the result of an API call using, in the depicted exemplary embodiment, the PAN, the authorization code, and an argument value in the form of a random number. The transaction token is stored in the token profile of the owner of the source of pre-established funds. The transaction token can be detokenized to form a data set that includes the authorization code, the random argument, and whatever USI was used in the creation of the transaction token, typically the PAN. While the transaction token was created at the initiation of the financial transaction, it is not necessarily sent to the venue 8 since the authorization code that was received at 216 would have been an authorization code that was responsive only to a nominal credit authorization. That is, the initial authorization for the credit card would have been for a nominal amount, typically $1 or $10, by way of example, or other such nominal amount, and would be the same amount for all such initial authorizations that are sought by the enterprise data system 6. It is expected that the user typically will charge to the existing tab more than the nominal $1 or $10, by way of example. Furthermore, the initiation notification that was sent, as at 220, to the venue 8 was merely a notification to the venue 8 that a tab has been opened and it is backed up by a valid and chargeable credit card.

With the tab being opened at the venue 8, charges can then be applied to the tab by the venue 8, such as for the purchase of food, beverages, merchandise, services, and the like without limitation. The routines 40 of the enterprise data system 6 advantageously mirror the financial transaction as items are added to the tab at the venue 8. The enterprise data system 6 thus at all times has in its storage 36 a mirror copy of the financial transaction, i.e., the tab, in its current and updated state. That is, as an item is added to the tab at the venue 8, the POS system at the venue 8 communicates the added item to the mirror copy of the tab that is stored in the storage 36 of the enterprise data system 6 by sending a charge notification or other signal to the enterprise data system 6. Such updated mirror copy is advantageously forwarded via the wireless data network 5 to the mobile electronic device 4 for viewing thereon. As such, the inventive app that is executed on the mobile electronic device 4 can be opened by the user and the current tab with details for all charges can be visually displayed on the visual display of the mobile electronic device 4, by way of example.

As charges are added to the tab, the enterprise data system 6 advantageously can again authorize the pre-established source of funds for progressively greater amounts of available funds, i.e., money. The initial authorization of the card was for a nominal $1 or $10 or other nominal amount. If it turns out that the credit card only had $11 of funds available, the initial authorization of $10 would have occurred because the issuing bank saw that the credit card had available the requested $10 of funds. If insufficient funds are available when the tab is sought to be closed for a higher dollar amount than the original authorization amount, i.e., an amount that exceeds the amount of available funds, the credit card will at that point be declined. If the tab is of an excessive amount, a declined credit card charge is undesirable due to potential financial loss by the venue 8.

In order to avoid this problem, the routines 40 on the enterprise data system 6 advantageously can repeatedly reauthorize the card as the tab grows in amount. Such reauthorization can occur at specific dollar amounts, i.e., $50, $100, $150, etc., or such reauthorizations can occur when each new item is added to the tab, and other variations will be apparent. Such reauthorizations do not incur any kind of transactional fee from the credit card company and are not treated as suspicious activity. As each such reauthorization occurs and the issuing bank returns to the enterprise data system 6 a new authorization code, the token service API creates a new transaction token that is stored in the UTV, and the earlier transaction token for that tab is deleted. If at some point during the course of the financial transaction the charge on the credit card is declined, such as when the enterprise data system 6 receives a decline message from the issuing bank, the current transaction token (i.e., the one previously created from the most recent authorization code) can be sent to the venue 8 to charge the credit card for whatever amount has most recently been authorized by the issuing bank. This would be done as partial payment for the tab. This advantageously avoids the user from running up a large tab without available funds to pay the tab. This reduces the risk of financial loss to the venue 8.

It is also understood that a given venue 8 might have a plurality of revenue center IDs. For example, a stadium might include numerous kiosks each of which sell food, beverages, and merchandise, by way of example, and which is a separate revenue center ID. The tab that is opened through the use of the improved app on the mobile electronic device 4 is advantageously operable at all of the kiosks, by way of example. When the tab is opened as a result of the sending of the initiation notification at 220, the enterprise data system 6 sends as part of the initiation notification the name of the user, i.e., the owner of the pre-established source of funds, and the user gains access to the tab by telling an employee at the kiosk, or at the bar or at the restaurant, by way of example, that a tab has been opened under the user's name and gives the user's name to the employee. The employee finds the tab and applies the charge for whatever food, beverage, etc., is being purchased at that time onto the tab.

The tab can remain open until the user affirmatively closes it, at which time the transaction will be closed, and the various entities involved with the credit card transaction will apply their charges as the funds are transferred from the issuing bank to the receiving bank that was established to receive funds that are being transferred to the venue in order to satisfy the obligation that arises from the financial transaction. As is understood, the charges typically are in the nature of a percentage of the total charge plus a fixed fee. By closing one tab only one time, the fixed fee is charged only one time. This saves money since, in the absence of the tab staying open for multiple purchases from multiple kiosks, each purchase of a food or beverage item at a different kiosk would be a separate credit card transaction with the percentage charge and the fixed fee charged with each credit card purchase. The percentage charge will be the same whether the total charges are the result of a plurality of individual credit card transactions or single credit card transaction. However, the multiple fixed fees that would be charged as a result of each of the plurality of credit card transactions are saved by having all of the charges charged in a single credit card transaction. Even though the amount of money that is charged in the fixed fee is relatively small in comparison with the total amount that is being charged, the repeated saving of this fixed fee can accumulate as a large overall savings, such as if 100,000 patrons at a sporting event each purchase two items. If the two items are charged in a single credit card transaction instead of two credit card transactions, savings to the venue 8 of one instance of the fixed fee saved multiplied by 100,000 patrons at a single sporting event is significant. Such savings are advantageous.

When it is desired to close the tab, processing can occur, as in FIG. 4. For instance, and as at 304, responsive to a predetermined event the enterprise data system 6 will communicate to the credit card company a final authorization request that the issuing bank authorizes use of a final amount of funds to pay the final amount of the obligation to the venue 8. In this regard, the final amount of funds will be the total of the charges that have been applied by the venue 8 for the purchase of food, beverage, merchandise, etc. by the user, plus an amount for sales tax, if applicable, and an amount of any gratuity that the user may have added. In this regard, the user may have employed the improved app on the mobile electronic device 4 and may have entered a closing input such as by selecting an option such as “CLOSE TAB” or other such command, which would open a dialog box that might provide a complete listing of all items on the tab and might provide an option for the user to enter a gratuity. Once the user enters the gratuity via a gratuity input, whatever that amount might be, that amount is added to the aforementioned charges and sales tax to result in a final amount that is to be charged to the credit card.

In such a situation, the predetermined event to communicate with the credit card company might be, for example, an input by the user to “CHARGE CREDIT CARD” or other such command that would trigger the enterprise data system 6 to send another authorization call to the credit card company which requests that the issuing bank authorize a charge for the final amount. If the issuing bank approves the charge, the issuing bank will return an authorization code to the credit card company, which will forward the authorization code to the enterprise data system 6 which will be received, as at 308, by the enterprise data system 6.

The enterprise data system 6 will then cause its token service API to generate, as at 312, a final transaction token that is based upon the final authorization code, the PAN, and argument in the form of a random number, and the transaction token is stored in the token profile. As before, the transaction token is capable of being detokenized to form a data set that includes the authorization code and the USI. Prior such detokenization, however, the transaction token is sent, as at 316, to a payment processor that is used by the venue 8 in payment of the obligation. Such payment processor, which is also known as a merchant processor, is in the form of a revenue center ID which is in the form of a URL to where the transaction token is sent. When the transaction token arrives at the revenue center ID, the transaction token automatically detokenizes into the PAN, the authorization code, and the argument value since the revenue center ID has been white listed by the enterprise data system 6. Such detokenization occurs automatically, which is to say that the detokenization operation is automated and occurs as a result of an API call by the merchant processor to the enterprise data system 6 which performs its own API call and forwards the argument to the payment processor. The payment processor API uses the argument to detokenize the transaction token into the PAN, the authorization code, and the argument.

The venue's payment processor then sends to the credit card company the authorization code that was generated by the issuing bank in response to the request for authorization of the final charge, the credit card company forwards the authorization code to the issuing bank, and the issuing bank transfers the funds in the amount of the final charge to the receiving bank and adds a corresponding entry for the final charge into the user's credit card bill. It is understood that the funds that are transferred to the receiving bank are not all fully available to the venue 8 until the various transactional charges are withdrawn on behalf of the credit card processor, the credit card company, and the issuing bank. The remaining funds are then available to the venue 8.

It is understood that various events can constitute the predetermined event at 304. For instance, the system may be set up such that all tabs are closed at a predetermined time, such as if the particular venue 8 closes at 2 AM, which will trigger the closing of all tabs at that time. It is also noted that each venue 8 has a geo-fence 48 which is a predefined region with respect to the venue and might be, for instance, a region within 100 feet of the front door of the venue or, by way of further example, anywhere within a one block radius of the street address, or other such predefined region. The mobile electronic device 4 includes the GPS receiver as part of the input apparatus 16, and location data of the mobile electronic device 4 is regularly being communicated via the wireless data network 5 to the enterprise data system 6, so the enterprise data system 6 generally always knows location of the mobile electronic device 4 and thus also know the proximity of the user of the mobile electronic device 4 with respect to the various venues 8.

The geo-fence 48 of venue 8 might additionally or alternatively be employed in the creation of the initiation input as at 204. For instance, an initiation input might be considered to be detected when a user provides a requesting input to start a tab at a venue 8 and is either physically present at the venue 8 or is on the way to the venue 8, such as by purchasing a private vehicle transport to that particular venue via Uber vehicle or other such service. In closing the tab, the geo-fence 48 could again be employed if, for instance, the user moves from a location within the geo-fence 48 while the tab is active to a location outside the geo-fence 48. Such movement to outside the geo-fence 48 might trigger the closing the tab.

Furthermore, an initiation input as at 204 might be prevented in certain circumstances. For instance, if a tab that was created via the enterprise data system 6 remains unpaid, in whole or in part, the enterprise data system 6 might not allow another tab to be opened by the user under any of the pre-established sources of funds until the unpaid tab is paid in full. The unpaid tab might be unpaid because it was never sought to be closed, because a credit card was declined, or for any of a variety of reasons.

Further regarding the initiation of the tab, as at 204, it is understood that the user might be prompted or otherwise invited to provide the initiation input to initiate the opening of tab at a given venue 8. For instance, if the user is in an Uber vehicle with the pre-established destination being the location of the venue 8, the enterprise data system 6 or the improved app on a mobile electronic device 4 might detect the pre-established destination as being the same as or close to the location of the venue and might prompt the user to open a tab at the venue 8. Other occurrences might prompt the opening of tab, such as if the user is situated nearby a particular venue 8 where a sporting event is about to begin, and the user may be prompted to purchase a ticket for the sporting event and be prompted to open a tab. Still alternatively, the mere physical presence of the user within the geo-fence 48 of a given venue 8 might prompt the user to open a tab for the venue 8. Other variations will be apparent.

As suggested hereinbefore, the routines 32 might include a number of vendor apps, also known as merchant apps, that enable the user to engage in commerce with a particular vendor. By interfacing the vendor app with the enterprise data system 6, the token service and the UTV that are afforded under the enterprise data system 6 are cooperable with the vendor app. As such, the user might use the vendor app to purchase an order of food from a restaurant for carryout. When the user issues a command to place an order and to thereby charge a pre-established source of funds, the token service detokenizes the smart token for that pre-established source of funds into a set of data that includes the USI for that credit card. The USI is then sent using HTTP basic encryption to the relevant credit card company along with an authorization request for the amount of the bill. If the issuing bank returns an authorization code via the credit card company, that authorization code and the smart token, along with a random number argument, are used to create a transaction token that is stored in the UTV and that is sent to the merchant processor 10 for that vendor in payment of the obligation. Upon the transaction token arriving at the merchant processor 10, the transaction token automatically detokenizes into a set of data that includes the USI, particularly the PAN, and the authorization code. The merchant processor 10 then communicates the authorization code to the credit card company, and the issuing bank transfers the funds to the acquiring bank set up by the merchant processor 10. By advantageously using the smart token that is already stored in the UTV, this avoids repeated entering of the same credit card for each vendor app that the user might wish to install on the mobile electronic device 4. This saves time and effort. Moreover, the retention of the smart tokens and the transaction tokens under the token profile of the owner and within the UTV avoids retaining USI, and rather results in retaining only a tokenized version of the USI, which is a secure way of storing such data and is thus advantageous.

As a general matter, it can be seen that the enterprise data system 6 performs much of the interaction with the credit card company and thus with the issuing bank through the credit card company, such as by requesting and receiving authorizations to charge credit cards. By sending to a revenue center of the venue 8 or the merchant processor 10 merely the authorization code as part of the transaction token, this avoids the need for the venue 8 and the merchant processor 10 to themselves perform such authorization calls with the credit card companies and waiting for authorization codes. By offloading such processing from the venues 8 and merchant processors 10, and by performing it with the enterprise data system 6, the costs incurred by the venues 8 and the merchant processors 10 in terms of computer cycles, communications bandwidth, and time are reduced, which provides for better functionality and provides for reduced cost, both of which are advantageous.

Further savings are obtained in the scenario where the credit card transaction is of the type where a gratuity would ordinarily be added by a user, but where the gratuity is not actually added to the charge until the tab is cashed out at the end of the night. In the conventional scenario which involves cashing out, the credit card processor was required to process the card twice, once when the tab was initially closed with an authorization code being returned by the issuing bank, and again when the gratuity was added during the cashing out operation and the card is again authorized for the full amount including the gratuity. While such double authorization of a single tab does not necessarily result in multiple transaction fees, it still requires the entire process of authorization request routed to the issuing bank and authorization code returned to the POS system to be performed twice. By avoiding such dual processing by the payment processor used at the venue, this reduces processing cycles and processing bandwidth, and if the credit card processor is not required to perform such operations twice for each tab, savings in processing effort is achieved, which is advantageous.

It thus can be seen that the system 2 and the various methods presented herein are advantageous because they reduce the risk and they reduce expense. They reduce risk by retaining smart tokens and transaction tokens in the UTV in the form of a token, which is secure. They reduce expense by reducing processing bandwidth and processing time by interfacing directly with the credit card companies, rather than requiring the credit card processor of each venue to perform such interfacing. Further expenses saved by reducing the quantities of credit card transactions by enabling a plurality of charges by a person to be charged a single credit card transaction rather than in multiple credit card transactions, with resultant savings of fixed fees and further savings of processing bandwidth and time. Multiple processing of a credit card charge to add a gratuity is also avoided since with the inventive app the gratuity is added by the user before the credit card is ever charged. Other benefits will be apparent.

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof.

What is claimed is:

1. A method of using a source of pre-established funds to perform a financial transaction with another, the another employing a payment processor, the financial transaction including a number of charges, at least a subset of the charges of the number of charges being added by the another during the financial transaction, the financial transaction including an obligation to pay the another for the number of charges, the source of pre-established funds having an amount of available funds, comprising:
receiving an initiation input that requests an initiation of the financial transaction;
detokenizing a token that is stored in a storage and that is representative of the source of pre-established funds to form a set of data that comprises a Primary Account Number (PAN) of the source of pre-established funds;
communicating to at least one of a credit card company and an issuing bank the PAN and an authorization request that the issuing bank authorize use of at least a portion of the amount of available funds to pay the obligation;
receiving an authorization code that is representative of an agreement by the issuing bank to make available the at least portion of the amount of available funds; and
responsive to the receiving of the authorization code, sending to the another an initiation notification that the financial transaction has been initiated.

2. The method of claim 1, further comprising:
storing a mirror copy of the transaction;
receiving a charge notification that the another has added a charge from among the number of charges to the financial transaction with a Point Of Sale (POS) system; and
updating the mirror copy to include the charge.

3. The method of claim 2, further comprising, responsive to the receiving of the charge notification, communicating to the at least one of the credit card company and the issuing bank another authorization request that the issuing bank authorize an additional amount that includes the charge to pay the obligation.

4. The method of claim 3, further comprising:
receiving a decline message that is representative of a notification by the issuing bank that the additional amount will not be available;
generating a transaction token that is based at least in part upon the authorization code and that can be detokenized to form a set of data that includes the authorization code; and
sending the transaction token to the payment processor in partial payment of the obligation.

5. The method of claim 2, further comprising forwarding the mirror copy to a mobile electronic device subsequent to the updating of the mirror copy.

6. The method of claim 1, further comprising sending to the another as the initiation notification a name of an owner of the source of pre-established funds.

7. The method of claim 1, further comprising:
detecting a location of a mobile electronic device that is used by an owner of the source of pre-established funds;
determining that the location is within a predetermined proximity of the another; and
performing at least one of the detokenizing, the communicating, and the sending responsive at least in part to the determining.

8. The method of claim 1, further comprising triggering the outputting on a mobile electronic device that is used by an owner of the source of pre-established funds an invitation to make the initiation input, the triggering being responsive to at least one of:
a determination that a location of the mobile electronic device is within a predetermined proximity of the another, and
a determination that the owner is traveling to the another.

9. The method of claim 1, further comprising:
receiving another initiation input that requests an initiation of another financial transaction;
making a determination that the obligation is unpaid and, responsive thereto, refraining from initiating the another financial transaction while the obligation remains unpaid.

10. The method of claim 1, further comprising receiving as a part of the initiation input a selection input that selects the source of pre-established funds for use in paying the obligation.

11. The method of claim 1, further comprising:
detecting a closing input;
communicating to at least one of the credit card company and the issuing bank another request that the issuing bank authorize use of another at least portion of the amount of available funds to pay the obligation;
receiving another authorization code that is representative of an agreement by the issuing bank to make available the another at least portion of the amount of available funds; and
sending the another authorization code to the payment processor in payment of the obligation.

12. The method of claim 11, further comprising:
again detokenizing the token to form another set of data that comprises the PAN;
communicating the PAN to the at least one of the credit card company and the issuing bank as a part of the another request;
generating a transaction token that is based at least in part upon the another authorization code and that can be detokenized to form a further set of data that includes the authorization code; and
sending the transaction token to the payment processor as the another authorization code.

13. A method of enabling a financial transaction using a source of pre-established funds having an amount of available funds to pay an obligation that is owed to another who employs a payment processor, comprising:
responsive to a predetermined event, communicating to at least one of a credit card company and an issuing bank an authorization request that the issuing bank authorize use of at least a portion of the amount of available funds to pay the obligation;
receiving an authorization code that is representative of an agreement by the issuing bank to make available the at least portion of the amount of available funds;
generating a transaction token that is based at least in part upon the authorization code and that can be detokenized to form a set of data that includes the authorization code; and
sending the transaction token to the payment processor in payment of the obligation.

14. The method of claim 13 wherein the generating of the transaction token comprises generating the transaction token based at least in part upon the authorization code and at least a portion of a Primary Account Number (PAN) of the source of pre-established funds and that can be detokenized to form a set of data that includes the authorization code and the at least portion of the PAN.

15. The method of claim 13, further comprising employing as the predetermined event at least one of:
a detection of a closing input on a mobile electronic device that is used by an owner of the source of pre-established funds,
a determination that a location of the mobile electronic device has moved from within a predetermined proximity of the another to beyond the predetermined proximity of the another, and
a predetermined hour at the another has been exceeded.

16. The method of claim 13 wherein the financial transaction includes a number of charges, at least a subset of the charges of the number of charges being added by the another during the financial transaction, and further comprising adding a gratuity to the number of charges to form the obligation.

17. The method of claim 16, further comprising adding the gratuity responsive to a detection of a gratuity input.

18. A method of making available a source of pre-established funds to perform a number of financial transactions, the source of pre-established funds having an amount of available funds, comprising:
receiving a registration input that comprises a Primary Account Number (PAN) of the source of pre-established funds;
communicating to at least one of a credit card company and an issuing bank the PAN and a request that the issuing bank authorize use of at least a portion of the amount of available funds;
receiving an authorization code that is representative of an agreement by the issuing bank to make available the at least portion of the amount of available funds;
responsive to the receiving of the authorization code, generating a token that is representative of the source of pre-established funds and that can be detokenized to form a set of data that includes the PAN;
storing the token in a secure storage; and
outputting an indication that the source of pre-established funds is available for use.

19. The method of claim 18, further comprising:
receiving a selection input that selects the source of pre-established funds for use in paying an obligation that is owed to another who employs a payment processor, the obligation being a part of a financial transaction of the number of financial transactions;
communicating to at least one of the credit card company and the issuing bank another request that the issuing bank authorize use of another at least portion of the amount of available funds to pay the obligation;
receiving another authorization code that is representative of another agreement by the issuing bank to make available the another at least portion of the amount of available funds; and
sending the another authorization code to the payment processor in payment of the obligation.

20. The method of claim 19, further comprising:
generating a transaction token that is based at least in part upon the another authorization code and that can be detokenized to form a set of data that includes the authorization code; and
sending the transaction token to the payment processor as the another authorization code.
